(19) United States
(12) Patent Application Publication
(10) Pub. No.: US 2017/0299400 A1
(43) Pub. Date: Oct. 19, 2017

(54) PARKING LOCATION CHECKING SYSTEM AND PARKING LOCATION CHECKING METHOD USING SAME

(71) Applicant: MALSAENG CO.,LTD., Seoul (KR)

(72) Inventors: Han Uk JOUNG, Seoul (KR); Yong Hwan LEE, Seoul (KR)

(21) Appl. No.: 15/511,963

(22) PCT Filed: Jun. 19, 2015
(86) PCT No.: PCT/KR2015/006247

§ 371 Date: May 31, 2017

(30) Foreign Application Priority Data
Jun. 20, 2014 (KR) 10-2014-0075536

(51) Int. Cl. G01C 21/36; H04W 4/04; H04W 4/02; G01S 19/45; H04M 1/725; G06K 9/00; H04W 4/20; H04W 4/00

(52) U.S. Cl. CPC G01C 21/3661; H04W 4/206; H04W 4/04; H04W 4/025; H04W 4/008; G01C 21/3697; H04M 1/72525; G06K 9/00671; G01S 19/45; H04M 2201/42

(57) ABSTRACT

Disclosed are a parking location checking system and a parking location checking method using the same, which can quickly and easily find a parking location even if a user who has parked a car in a parking lot does not remember the location of the parking section in which the car is parked, and can guide the user to the parking location and, simultaneously, even transmit various types of information or advertisement content to the user by executing the various type of information or advertisements through a smartphone. The parking location checking system and the parking location checking method using the same can quickly and easily find the parking section in which a car is parked just by allowing a smartphone to approach or come in contact with an NFC tag even if a user does not remember the location of the parking lot in which the user's car is parked, thereby remarkably improving the user's convenience and even creating additional profits by posting an advertisement therein while using the parking location checking system.

### CROSS-REFERENCE TO RELATED APPLICATIONS

This patent application is a national-stage application of International Patent Application No. PCT/KR2015/006247 filed on Jun. 19, 2015, which claims priority under 35 U.S.C. §119 to Korean Patent Application No. 10-2014-0075536, filed on Jun. 20, 2014, in the Korean Intellectual Property Office, the disclosure of which is incorporated by reference herein in its entirety.

### TECHNICAL FIELD

The present invention relates to a parking location checking system and a parking location checking method using the same, and more specifically to, a parking location checking system and a parking location checking method using the same allowing a user to check the user's vehicle-parked location using a smartphone and a near field communication (NFC) tag.

### DISCUSSION OF RELATED ART

Recently, due to a high standard of living and developed automobile industry, vehicles have become a necessity for daily life, and thus the number of vehicles has rapidly increased.

As a result, parking lots provided for buildings, e.g., large shopping malls, large marts, department stores, amusement parks, and apartment buildings, become larger and are formed on multiple floors. Further, since a large number of vehicles are parked in a small space, the structure of the parking lot is getting more complicated.

In particular, a large-scale building structure such as a plurality of buildings adjacent to each other as described above is generally constructed with multiple floors of parking lots under the building, and the parking lot is formed not to be divided according to the locations of the buildings but to be integrated into one so that a very large area can be used as a parking lot.

As such, since the parking lot is very wide and complicated, the vehicle's owner parks his or her vehicle at a desired location and then needs to remember the parking section number, e.g., displayed on the parking lot column and parking lot floor where the vehicle is parked, so that the user may find the vehicle-parked location for returning home.

However, although the owner of the vehicle remembers the parking section number and the parking lot floor in which the vehicle is parked, if the parked parking lot is an underground parking lot, the owner may lose sense of space so that it is difficult to find the vehicle-parked location.

When the owner cannot remember the parking section number and the parking lot floor in which the vehicle is parked, the user must walk through the entire parking lot and find his or her parking spot for a long time.

### SUMMARY

Accordingly, an object of the present invention is to provide a parking location checking system and a parking location checking method using the same that enables a user who parks his or her vehicle in a parking lot to quickly and easily find a parking location even if the user does not remember the location of the parking section in which the vehicle is parked.

Another object of the present invention is to provide a parking location checking system and a parking location checking method using the same that executes various information and advertisements through a smartphone to transfer the information and advertisement contents to the user while informing the user of the parking location.

Other detailed objects of the present invention will be apparently understood by those skilled in the art from the following detailed descriptions.

To achieve such objects, the present invention is to provide a parking location checking system comprising a first near field communication (NFC) tag attached to at least one parking section of a parking lot and storing location information on the parking section, a smartphone receiving the location information on a user's vehicle-parked section and the parking lot's feature information from the first NFC tag and storing the same when the smartphone is brought close or in contact to the first NFC tag attached to the user's vehicle-parked section after parking the vehicle on a desired parking section, so that when the user confirms the vehicle-parked location, the smartphone displays the location information on the vehicle-parked section, which is transmitted from the first NFC tag to be stored, so as to transmit such information to the user so as to receive and store the location information on the user's vehicle-parked section and the parking lot's feature information from the first NFC tag, and a server transmitting an image of the user's vehicle-parked section to the smartphone when the user checks the location of the user's vehicle-parked section through the smartphone, so that the user confirms the image of the vehicle-parked section, which is displayed through the smartphone.

Meanwhile, a parking location checking system according to an embodiment of the present invention may further comprise a camera taking an image of a parking section to which the first NFC tag is attached in real time and transmitting the image to the server when the user brings the smartphone close or in contact to the first NFC tag.

Herein, when the smartphone receives and stores the location information of the user's vehicle-parked section from the first NFC tag, the smartphone may execute an advertisement

Further, the smartphone executes the location information on the user's vehicle-parked section or the advertisement or the information to be transferred to the user when the smartphone displays the image of the parking section where the user's vehicle is parked.

Further, a parking location checking system according to an embodiment of the present invention may further comprise a second NFC tag attached to a structure or an entrance connected to the parking lot, transmitting information of a map of the parking section and user's current location information to the smartphone when the user brings the smartphone close or in contact to the second NFC tag so that the user is guided by the smartphone to the user's vehicle-parked location, and storing parking lot's feature information on whether a user's vehicle-parked lot is a ground parking lot or an underground parking lot.

For example, while the smartphone receives and displays information on a map of the parking lot from the second NFC tag, a moving line from the user's current location to the location of the user's vehicle-parked section using the user's current location information transmitted from the second NFC tag and the location information on the user's vehicle-parked section transmitted from the first NFC tag may be displayed on the map of the parking lot.

For example, when the smartphone receives the parking lot's feature information from the second NFC tag and determines that the user's vehicle-parked lot is a ground parking lot, the smartphone operates a global positioning system (GPS) to display a direction and distance from the user's current location to the location of the user's vehicle-parked section, so as to guide the user.

Herein, the user can be guided by augmented reality where the smartphone displays the direction and distance from the user's current location to the location of the parking section on a screen with the real world displayed by the embedded camera operation.

Meanwhile, the user can be guided by virtual reality where the smartphone displays the direction and distance from the user's current location to the location of the vehicle-parked section on a virtual image of the parking lot displayed on the smartphone, transmitted from the server.

For example, the smartphone operates a geomagnetic sensor to display a direction and distance from the user's current location to the location of the user's vehicle-parked section, so as to guide the user when the smartphone receives the parking lot's feature information from the second NFC tag and determines that the user's vehicle-parked lot is an underground parking lot.

Herein, the user can be guided by virtual reality where the smartphone displays the direction and distance from the user's current location to the location of the vehicle-parked section on a virtual image of the parking lot displayed on the smartphone, transmitted from the server.

To achieve such objects, the present invention is to provide a parking location checking method, comprising the steps of transmitting and storing location information and parking lot's feature information on a user's vehicle-parked section from a first near field communication (NFC) tag to a smartphone by bringing smartphone close or in contact to the first NFC tag attached to the parking section after parking, a step of transmitting an image of the user's vehicle-parked section from a server to the smartphone and storing the same, and displaying an image of the user's vehicle-parked section while displaying the location information on the user's vehicle-parked section by operating the smartphone.

For example, the step of transmitting the image of the user's vehicle-parked section from the server to the smartphone and storing the same may comprise the steps of transmitting and storing a pre-taken image per parking section in the server, transmitting the location information on the vehicle-parked section, which is stored in the smartphone to the server, and receiving the image of the parking section from the server and storing the same on the smartphone, which is identical to the location information on the parking section where the vehicle is parked, stored in the smartphone.

For example, the step of transmitting and storing an image of the user's vehicle-parked section from the server to the smartphone may comprise the steps of taking an image of the user's vehicle-parked section in real time by operating a camera installed on a portion where the first NFC tag is positioned when the smartphone is brought close or in contact to the first NFC tag attached to the user's vehicle-parked section and transmitting the image to the server and receiving and storing the image of the user's vehicle-parked section from the server by the smartphone brought close or in contact to the first NFC tag.

Meanwhile, the step of transmitting the image of the user's vehicle-parked section from the server to the smartphone and storing the same in the smartphone may include the smartphone's execution of the advertisement or information to be transferred to the user.

Further, the step of displaying the image of the user's vehicle-parked section while displaying the location information on the user's vehicle-parked section by operating the smartphone may include the smartphone's execution of the advertisement or the information to be transferred to the user.

Further, a parking location checking method according to an embodiment of the present invention may further comprise the steps of transmitting the parking lot's feature information and user's current location information to the smartphone by bringing the smartphone close or in contact to a second NFC tag and guiding the user from the current location to the user's vehicle-parked location by the smartphone.

For example, the step of guiding the user from the current location to the user's vehicle-parked location by the smartphone may comprise the steps of receiving a map of the parking lot from the second NFC tag to display the map of the parking lot and displaying a moving line from the user's current location to the location of the user's vehicle-parked section using the user's current location information transmitted from the second NFC tag and the location information on the user's vehicle-parked section transmitted from the first NFC tag on the map of the parking lot.

The step of guiding the user from the current location to the user's vehicle-parked location by the smartphone may comprise the steps of determining whether the user's vehicle-parked lot is a ground parking lot or an underground parking lot by transmitting the parking lot's feature information from the second NFC tag to the smartphone and a step of operating global positioning system (GPS) mounted in the smartphone when the smartphone determines that the parking lot is a ground parking lot or operating a geomagnetic sensor when the smartphone determines that the parking lot is an underground parking lot so that the smartphone displays a direction and distance from the user's current location to the location of the user's vehicle-parked section and guides the user.

Herein, when the smartphone determines that the parking lot is a ground parking lot and operates the GPS, the user may be guided through augmented reality where the smartphone displays the direction and distance from the user's current location to the location of the parking section on a screen with the real world displayed by the smartphone's operation of the camera.

Further, when the smartphone determines that the parking lot is a ground parking lot and operates the GPS, the user may be guided through virtual reality where the smartphone displays the direction and distance from the user's current location to the location of the vehicle-parked section on a virtual image of the parking lot displayed on the smartphone, transmitted from the server.

Meanwhile, when the smartphone determines that the parking lot is an underground parking lot and operates the geomagnetic sensor, the user may be guided through virtual reality where the smartphone displays the direction and distance from the user's current location to the location of the vehicle-parked section on a virtual image of the parking lot displayed the smartphone, transmitted from the server

As described above, according to a parking location checking system and a parking location checking method using the same, when the smartphone is merely brought close or in contact to the first NFC tag, the location information on the user's vehicle parked parking section is stored on the smartphone, and then a dedicated application installed in the smartphone is executed, the smartphone displays the location information as well as a photograph of the user's vehicle parked parking section.

Accordingly, although the user does not remember the parking location where the vehicle is parked, it is very convenient for the user because the user may easily find the parking location where the vehicle is parked.

Further, in the case of a parking lot having a complicated structure, when the user brings the smartphone close or in contact to the second NFC tag, while a map of the parking lot is displayed on the smartphone, a moving line from the user's current location to the vehicle-parked section is overlaid on the map and displayed on the smartphone.

In addition, in the case of a parking lot with a complicated structure, when the user brings the smartphone close or in contact to the second NFC tag, the direction and distance from the user's current position to the parking section where the vehicle is parked are displayed on the smartphone by the augmented reality or virtual reality, and thus the user is guided through the smartphone.

Thus, it is very convenient for the user because the user may easily and quickly find the parking location where the vehicle is parked.

Further, when the location of the parking section is stored in the smartphone, or when the location information or the photograph of the parking section is displayed or guided through the smartphone, the advertisement can be executed through the smartphone so that an additional profit can be earned through the advertisement while using the parking location checking system.

The effects of the present invention will be apparently understood by those skilled in the art through the specific details described below, or during performing the present invention.

### BRIEF DESCRIPTION OF THE DRAWINGS

FIG. 1 is a block diagram illustrating a parking location checking system according to an embodiment of the present invention,

FIG. 2 is a flowchart illustrating a parking location checking method according to an embodiment of the present invention,

FIG. 3 is a flowchart illustrating step S130,

FIG. 4 is another flowchart illustrating step S130,

FIG. 5 is a flowchart illustrating step S140 according to an embodiment of the present invention, and

FIG. 6 is another flowchart illustrating step S140 according to another embodiment of the present invention.

### DETAILED DESCRIPTION OF EXEMPLARY EMBODIMENTS

The present invention is capable of various modifications and forms, and specific embodiments are illustrated in the drawings and described in detail in the specification. However, it should be understood that the present invention is not intended to be limited to the particular forms disclosed, but is intended to include all modifications, equivalents, and alternatives falling within the spirit and scope of the present invention.

The terms, e.g., first and second, may be used to describe various elements, but the elements should not be limited by the terms. The terms are used only for the purpose of distinguishing one element from another. For example, without departing from the scope of the present invention, a first element may be referred to as a second element, and similarly, a second element may also be referred to as a first element.

The term used herein is for the purpose of describing particular embodiments only and is not intended to limit the present invention. The singular forms “a,” “an,” and “the” include plural forms unless the context clearly dictates otherwise. It should be understood that the terms, e.g., “comprise” and “having,” are used to specify that a feature, a number, a step, an operation, an element, a component, or a combination thereof is present, but do not preclude the presence or addition of one or more other features, numbers, steps, operations, elements, parts, or combinations thereof in the specification

Unless defined otherwise, all terms used herein, including technical or scientific terms, have the same meaning as are commonly understood by one of ordinary skill in the art to which the present invention belongs.

Terms such as those defined in commonly used dictionaries are to be interpreted in a meaning consistent with the meaning in the context of the relevant art. Unless expressly defined in the present application, the terms are not to be construed in an ideal or overly formal sense.

Hereinafter, preferred embodiments of the present invention will be described in detail with reference to the drawings.

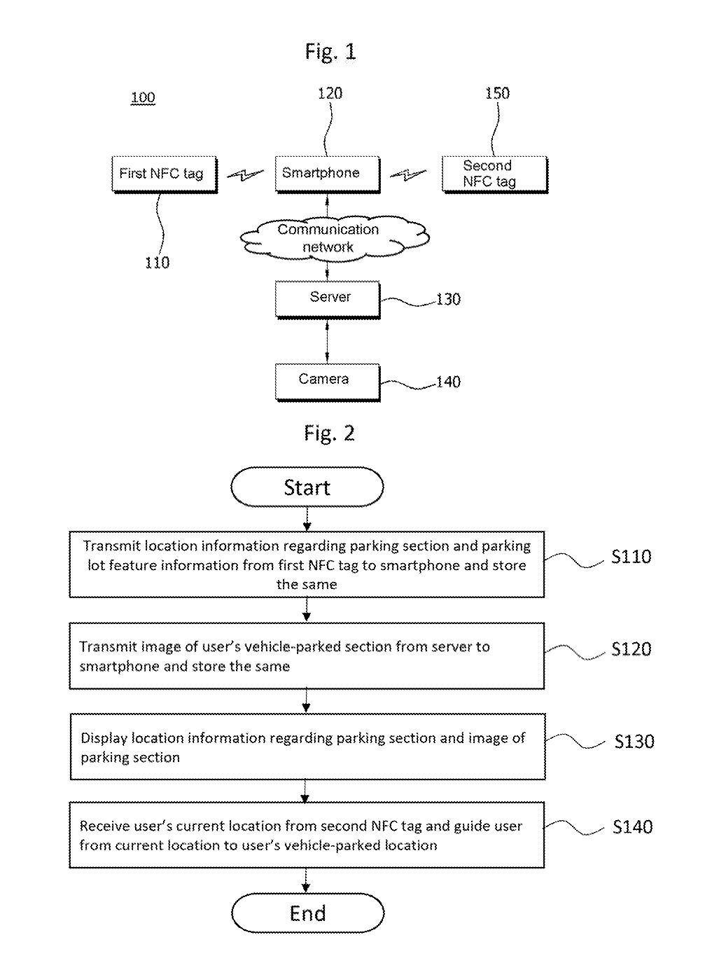

FIG. 1 is a block diagram illustrating a parking location checking system according to an embodiment of the present invention.

Referring to FIG. 1, according to an exemplary embodiment of the present invention, a parking location checking system 100 may include a first NFC tag 110, a smartphone 120, and a server 130.

The first NFC tag 110 may be attached to at least one parking section of the parking lot. Here, the first NFC tag 110 may store location information on the parking section and parking lot's feature information on whether the parking lot where the user's car is parked is a ground parking lot or an underground parking lot and on the number of floors of the parking lot.

For example, the location information on the parking section stored on the first NFC tag 110 may include, e.g., the number of floors of the parking lots or a number of the parking section marked on the column of the parking lot.

When the smartphone 120 is brought close or in contact to the first NFC tag attached to the parking section where the user's vehicle is parked after the user parks his or her vehicle on a desired parking section, the smartphone 120 may receive a parking lot's feature information and the location information on the user's vehicle-parked location from the first NFC tag and store the same. Thus, when the user needs to find a parking location where the user's vehicle is parked, and thus operates the smartphone, the smartphone displays the location information on the vehicle-parked section transmitted from the first NFC tag and stored in the smartphone to transfer the information to the user.

Herein, the smartphone 120 is capable of wireless communication through a mobile communication network and is equipped with a camera, a geomagnetic sensor, a near field communication (NFC) chip, and an air pressure sensor. By an application installed in the smartphone 120, the location information on the vehicle-parked section transmitted from the first NFC tag 110 and stored in the smartphone 120 is displayed to transfer the information to the user.

When the smartphone 120 receives the location information on the vehicle-parked section, and an application for guiding the location information on the parking section is installed, the application is executed to display the location information on the parking section and to transfer the information to the user. When the application for guiding the location information on the parking section is not installed, the smartphone 120 is connected to a website where the user can install the application. Then, the application for guiding the location information on the parking section is installed, and then the smartphone 120 may display the location information on the parking section though the application.

When the user checks the location of the parking section where the user parked the vehicle through the smartphone 120, the server 130 transmits an image of the user's vehicle-parked section to the smartphone 120. Thus, the image of the parking section in which the user's vehicle is parked is also displayed on the smartphone 120 so that the user can view the image.

Herein, the server 130 is capable of wireless communication with the smartphone 120 through a mobile communication network. Accordingly, when the smartphone 120 is brought close or in contact to the first NFC tag 110 to receive and store the parking lot's feature information and the location information on the user's vehicle-parked section, the smartphone 120 is connected to the server 130 by wireless communication through a mobile communication network and transmits the location information on the user's vehicle-parked lot to the server 130.

For example, the server 130 may pre-take an image of each parking section of the parking lot to which the first NFC tag 110 is attached and store the image. Such server 130 may be connected to the smart phone 120 through wireless communication. Accordingly, when the location information on the parking section in which the user's vehicle is parked is transmitted from the smartphone 120 to the server 130, the server 130 transmits an image of a parking section matching the location information on the user's vehicle-parked section, and thus the image may be displayed on the smartphone 120.

Further, the server 130 may store information on a map of the parking lot.

Meanwhile, the parking location checking system according to an embodiment of the present invention may further comprises a plurality of cameras 140.

Here, the camera 140 may be connected to the server 130 through wireless communication. Accordingly, when the smartphone 120 transmits the location information on the user's vehicle-parked section to the server 130, a control unit (not shown) provided in the server operates the camera 140 installed at a location matching the location information on the user's vehicle-parked section and thus take an image of the user's vehicle-parked section. Meanwhile, the image of the user's vehicle-parked section taken by the camera 140 is transmitted to the server 130 and then transmitted from the server 130 to the smartphone 120 of the user so that the smartphone 120 may display the image.

Meanwhile, when the smartphone 120 receives the parking lot's feature information and the location information on the user's vehicle-parked section and stores the information, the smartphone 120 may execute the advertisement or information to be transferred to the user.

Further, when the smartphone 120 displays the image or location information on the user's vehicle-parked section, the smartphone 120 may execute the advertisement or information to be transferred to the user.

For example, when the parking lot where the user's car is parked is a parking lot in an apartment building, a dedicated application may be operated to display information informing the residents of, e.g., neighborhood information and living information of the apartment building. When the parking lot where the user's car is parked is a parking lot in, e.g., a large mart, a shopping mall, and a department store, the dedicated application may be operated to display various events and discount information.

For another example, when the smartphone 120 receives the parking lot's feature information and the location information on the user's vehicle-parked section from the first NFC tag 110 and stores the information, the smartphone 120 may transmits information, such as “Welcome, it is on sale on the second floor,” to the user.

Meanwhile, the parking location checking system 100 according to an embodiment of the present invention may further comprise a second NFC tag 150.

The second NFC tag 150 may be attached to a structure or an entrance connected to the parking lot.

For example, the second NFC tag 150 may be attached to a structure, e.g., an elevator and an escalator, connected to the parking lot, or an entrance connected to the parking lot.

Here, the second NFC tag 150 may store information on a location to which the second NFC tag 150 is attached. The information on the location to which the second NFC tag 150 is attached may include which story of the parking lot the location to which the second NFC tag 150 is attached is present on.

Therefore, when the user returns to the parking lot after his or her work is done, if the user brings the smartphone 120 close or in contact to the second NFC tag 150 attached to the elevator or escalator connected to the parking lot or the entrance connected to the parking lot, the server 30 may transmit information on a map of the parking lot and the user's current location to the smartphone 120. In other words, the server 130 may transmit, to the smartphone 120, the information on the location of the second NFC tag 150 to which the smartphone is brought close or contacted by the user. Herein, the dedicated application may be executed on the smartphone 120 to guide the user from the current location to the user's vehicle-parked location.

Meanwhile, when the smartphone 120 is brought close or in contact to the second NFC tag 150, the advertisement or the information to be transferred to the user can be executed.

For example, when the parking lot where the user's car is parked is a parking lot in an apartment building, the dedicated application may be operated to display information informing the residents of, e.g., neighborhood information and living information of the apartment building. When the parking lot where the user's car is parked is a parking lot in, e.g., a large mart, a shopping mall, and a department store, the dedicated application may be operated to display various events and discount information.

For another example, when the smartphone is brought close or in contact to the second NFC tag 150, information such as “Goodbye, next sale is on 0000” can be delivered to the user though the speaker.

Herein, when the smartphone 120 receives the user's current location information from the second NFC tag 150, while the dedicated application is operated to display the map of the parking lot, transmitted from the server 130, a moving line from the user's current location to the location of the user's vehicle-parked section is overlaid and displayed on the map of the parking lot, displayed on the smartphone, using the user's current location information transmitted from the second NFC tag 150 and the location information on the vehicle-parked section transmitted from the first NFC tag 110, so as to guide the user to the location where the vehicle is parked.

Further, the second NFC tag 150 may also store parking lot's feature information on whether the user's vehicle-parked lot is a ground parking lot or an underground parking lot.

Here, when the smartphone 120 receives the parking lot's feature information from the second NFC tag 150 and determines that the user's vehicle-parked lot is a ground parking lot having an environment that may operate the GPS, while the embedded GPS is operated to display a direction and distance from the user's current location to the location of the user's vehicle-parked section, to display a change of a remaining distance and direction of the user in real time to the location of the user's vehicle-parked section, so as to guide the user.

For example, the user is guided through augmented reality where the smartphone displays the direction and distance from the user's current location to the location of the vehicle-parked section.

In a more specific description, when the smartphone 120 receives the parking lot's feature information from the second NFC tag 150 and determines that the user's vehicle-parked lot is a ground parking lot having an environment that may operate the GPS, the embedded GPS and camera are operated. As such, when the embedded camera is operated to display a screen with the real world on the smartphone 120, while the smartphone 120 displays the direction and distance from the user's current location to the location of the user's vehicle-parked section, the smartphone 120 displays a change of the remaining distance and direction of the user in real time to the location of the user's vehicle-parked section. Thus, by the augmented reality, the user may be more realistically guided from the current location to the location of the parking section where the user's vehicle is parked.

For another example, the smartphone 120 may display the direction and the distance from the current location to the location of the parking section where the user's vehicle is parked through the virtual reality to guide the user.

In a more specific description, when the smartphone 120 receives the parking lot's feature information from the second NFC tag 150 and determines that the user's vehicle-parked lot is a ground parking lot having an environment that may operate the GPS, while the embedded GPS is operated, the virtual image of the parking lot pre-stored in the server 130 is received from the server 130 and displayed. Then, while the direction and the distance to the location of the user's vehicle-parked section are displayed on the virtual image of the parking lot using the user's current location acquired through the GPS, a change of the remaining distance and direction of the user in real time on moving to the location of the user's vehicle-parked section is displayed. Thus, by the virtual reality, the user may be guided from the current location to the location of the parking section where the user's vehicle is parked.

Meanwhile, when the smartphone 120 receives the parking lot's feature information from the second NFC tag 150 and determines that the user's vehicle-parked lot is an underground parking lot in which the GPS is not operated, the geomagnetic sensor is operated to display the direction and distance from the user's current location to the location of the vehicle-parked section, so as to guide the user.

For example, the smartphone 120 may display the direction and the distance from the current location to the location of the parking section where the user's vehicle is parked through the virtual reality to guide the user.

In a more specific description, when the smartphone 120 receives the parking lot's feature information from the second NFC tag 150 and determines that the user's vehicle-parked lot is an underground parking lot having an environment that may not operate the GPS, while the embedded geomagnetic sensor is operated, the virtual image of the parking lot pre-stored in the server 130 is received from the server 130 and displayed. Then, the direction and the distance to the location of the user's vehicle-parked section are displayed on the virtual image of the parking lot using the user's current location acquired through the geomagnetic sensor. Thus, the user may be guided by the virtual reality from the current location to the location of the parking section where the user's vehicle is parked.

Meanwhile, the smartphone 120 can recognize the number of floors of the parking lot where the user is located using the air pressure sensor in the underground parking lot. Therefore, the smartphone 120 may determine whether the number of floors of the parking lot in which the vehicle is parked is the same as the number of floors of the parking lot in which the user is currently located.

Further, when the GPS may be operated in the underground parking lot, as described above, while using the user's current location acquired though the GPS, the direction and the distance to the location of the user's vehicle-parked section are displayed on the screen with the real world obtained by the augmented reality or the virtual image of the parking lot obtained by the virtual reality, a change of the remaining distance and direction of the user on moving to the location of the user's vehicle-parked section is displayed. Thus, the user can be guided from the current location to the location of the user's vehicle-parked section.

Referring to FIGS. 1 to 6, a parking location checking system and parking location checking method using the same according to an embodiment of the present invention will be described in detail.

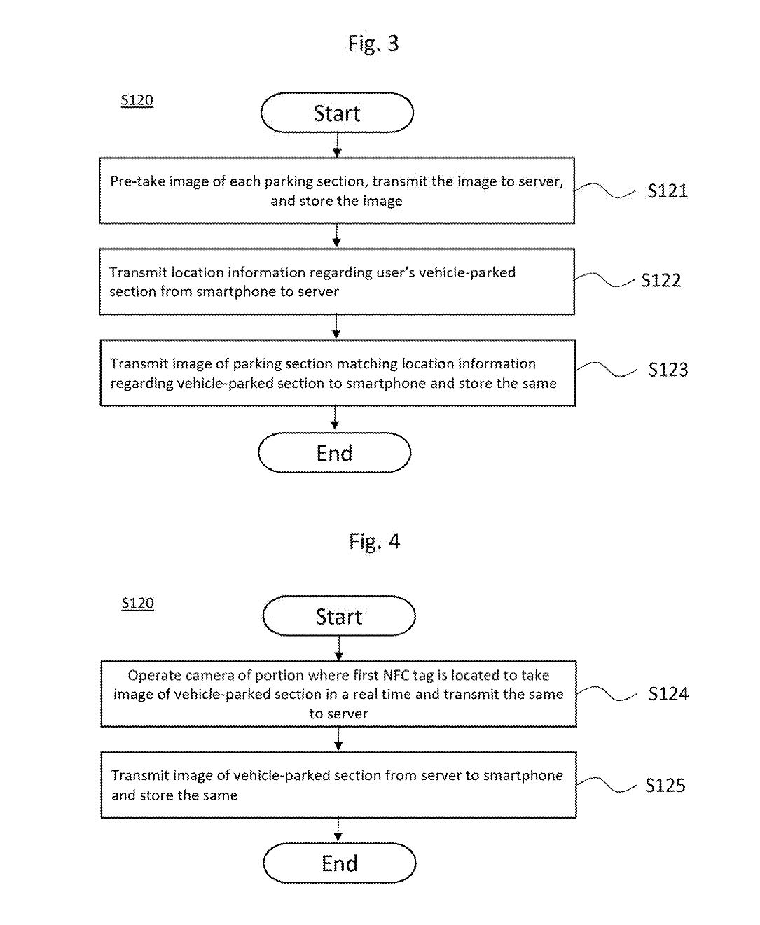

FIG. 2 is a flowchart illustrating a parking location checking method according to an embodiment of the present invention, FIG. 3 is a flowchart illustrating step S130, and FIG. 4 is another flowchart illustrating step S130.

Referring to FIG. 2, the user first parks his or her vehicle in a desired parking section, using a parking location checking system 100 according to an embodiment of the present invention, in order to check a parking location by a user, and then brings the smartphone close or in contact to the first NFC tag attached to the parking section. Thus, the smartphone 120 receives the parking lot's feature information and the location information on the parking lot in which the user's vehicle is parked from the first NFC tag 110 and stores the information (SI 10).

Then, the server 130 transmits the image of the parking section where the user's vehicle is parked to the smartphone 120, and the smartphone 120 stores the image (S120).

An embodiment of the step of S120 will be described with reference to FIG. 3.

Referring to FIG. 3, in order to transmit the image of the user's vehicle-parked section from the server 130 to the smartphone 120, first, each parking section's image is pre-taken and then is transmitted to the server 130 to be stored (S121).

Then, the smartphone 120 transmits the location information on the user's vehicle-parked section to the server 130 (S122).

When the location information on the user's vehicle-parked section is transmitted from the smartphone 120 to the server 130, the server 130 searches an image of the parking section matching the location information on the user's vehicle-parked section and transmits the image to the smartphone 120. The smartphone 120 receives and stores the image (S123).

Another embodiment of the step of S120 will be described with reference to FIG. 4.

Referring to FIG. 4, in order to transmit the image of the user's vehicle-parked section from the server 130 to the smartphone 120 to be stored, first, when the smartphone 120 is brought close or in contact to the first NFC tag attached to the user's vehicle-parked section, the camera installed in a portion where the first NFC tag is positioned is operated to take an image of the user's vehicle-parked section in a real time and transmit the image to server 130 (S124).

Then, the server 130 transmits the image of the user's vehicle-parked section to the smartphone 120 brought close or in contact to the first NFC tag, and thus the smartphone stores the image (S125).

Meanwhile, in the step of S120 receiving the image of the user's vehicle-parked section from the server 130 to the smartphone 120 and storing the image by the smartphone 120, the smartphone executes and displays an advertisement or information to be transferred to the user, and thus the advertisement or the information is transferred to the user.

As such, after the image of the user's vehicle-parked section is transmitted from the server 130 to the smartphone 120, in order to find his or her own vehicle-parked section after the user finishes his or her work, when the dedicated application installed in the smartphone 120 is operated, while the smartphone 120 displays the location information on the user's vehicle-parked section, the smartphone 120 displays the image of the user's vehicle-parked section (S130).

Herein, while the smartphone 120 displays the image and the location information on the user's vehicle-parked section, the smartphone 120 executes the advertisement or the information to be transferred to the user.

Meanwhile, the parking location checking method using the parking location checking system 100 according to an embodiment of the present invention may further comprise the step (S140) that the smartphone is brought close or in contact to the second NFC tag 150 attached to a structure or an entrance connected to the parking lot so that the parking lot's feature information and the user's current information are transmitted to the smartphone 120, and thus the user can be guided from the current location to the user's vehicle-parked location by the smartphone 120.

Herein, when the smartphone is brought close or in contact to the second NFC tag, the smartphone may execute the advertisement of the information to be transferred to the user.

For example, the information on the parking lot may be information on the map of the parking lot or the parking lot's feature information on whether the parking lot is a ground parking lot or an underground parking lot.

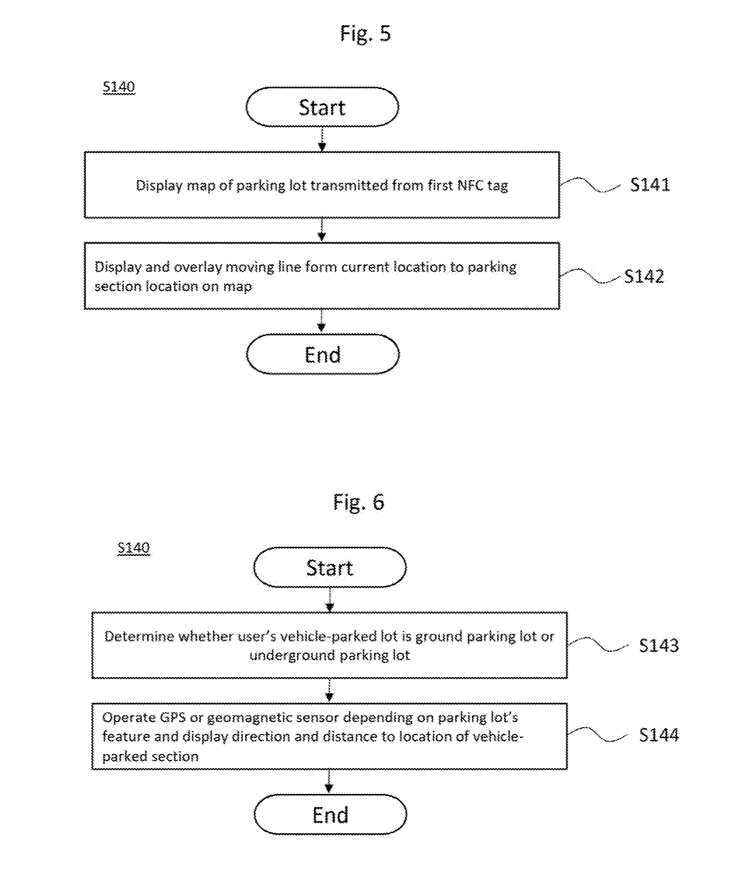

An embodiment of the step of S140 will be described with reference to FIG. 5.

FIG. 5 is a flowchart illustrating step S140 according to an embodiment of the present invention.

Referring to FIG. 5, in order to guide the user from the current location to the user's vehicle-parked location by the smartphone 120, first, the smartphone 120 receives the information on the map of the parking lot from the server 130 and then displays the map (S141).

Then, using the user's current location information transmitted from the second NFC tag 150 and the parking lot's feature information and the location information on the vehicle-parked section transmitted from the first NFC tag 110, the moving line from the user's current location to the location of the vehicle-parked section is overlaid and displayed on the map of the parking lot (S142).

Next, another embodiment of the step of S140 will be described with reference to FIG. 6.

FIG. 6 is another flowchart illustrating step S140 according to another embodiment of the present invention.

Referring to FIG. 6, in order to guide the user from the current location to the user's vehicle-parked location by the smartphone 120, first, the smartphone 120 receives the parking lot's feature information from the second NFC tag 150 and thus determines whether the parking lot is a ground parking lot or an underground parking lot (S143).

Next, when the smartphone 120 determines that the parking lot is a ground parking lot, the GPS installed in the smartphone 120 is operated to display the direction and the distance from the current location to the location of the user's vehicle-parked section, guiding the user, or when the smartphone 120 determines that the parking lot is an underground parking lot, the geomagnetic sensor installed in the smartphone 120 is operated to display the direction and the distance from the current location to the location of the user's vehicle-parked section, guiding the user (S144).

For example, when the smartphone 120 determines that the parking lot is a ground parking lot having an environment that may operate the GPS and thus the embedded GPS is operated, the user can be guided through the augmented reality where while the direction and distance from the user's current location to the location of the user's vehicle-parked section are displayed on the screen with the real world, displayed by operating the embedded camera by the smartphone 120, a change of a remaining distance and direction in real time to the location of the user's vehicle-parked section during the user's moving is displayed.

For example, when the smartphone 120 determines that the parking lot is a ground parking lot having an environment that may operate the GPS and thus the embedded GPS is operated, the user can be guided through the virtual reality where while the direction and distance from the user's current location to the location of the user's vehicle-parked section are displayed on the displayed virtual image of the parking lot transmitted from the server 130, a change of a remaining distance and direction in real time to the location of the user's vehicle-parked section during the user's moving is displayed.

Herein, the virtual image of the parking lot may be pre-manufactured to be stored in the server 130. The virtual image of the parking lot may be prepared in two dimension (2D) or three dimension (3D).

Meanwhile, when the smartphone 120 determines that the parking lot is an underground parking lot having an environment that may not operate the GPS, and thus the geomagnetic sensor is operated without operation of the GPS, the user can be guided through the virtual reality where the direction and distance from the user's current location to the location of the user's vehicle-parked section are displayed on the displayed virtual image of the parking lot transmitted from the server 130.

Meanwhile, when the smartphone 120 displays the direction and distance from the user's current location to the location of the user's vehicle-parked section so that the user is guided to the location of the user's vehicle-parked section, the smartphone 120 may execute the advertisement or the information to be transferred to the user and thus to be exposed to the user.

The effects of the parking location checking system and the parking location checking method using the same according to an embodiment of the present invention will be described with reference to FIGS. 1 to 6.

Referring to FIGS. 1 to 6, in the parking location checking system and the parking location checking method using the same according to an embodiment of the present invention, although the smartphone 120 is brought close or in contact to the first NFC tag attached to the parking section after the user parks his or her vehicle on a desired parking section, the first NFC tag transmits the location information on the user's vehicle-parked section to the smartphone 120, and thus the smartphone 120 stores the information.

Accordingly, although the user does not remember the vehicle-parked section, when the user operates only dedicated application installed in the smartphone 120, the location of the user's vehicle-parked section, i.e., the number of floor of the parking lot and the number of the parking section, as well as the image of the user's vehicle-parked section are displayed on the smartphone 120 so that the user may easily find the user's vehicle-parked section.

Further, in the case of a parking lot having a complicated structure such as a large shopping mall, a mart or a department store, when the smartphone 120 is brought close or in contact to the second NFC tag 150 attached to an elevator or an escalator connected to the parking lot, or attached to an entrance connected to the parking lot, a distance to be moved using, e.g., a number, and a direction using, e.g., an arrow mark, are displayed on the smartphone 120, and thus the user is guided from the current location of the user to the vehicle-parked section by the smartphone 120. Thus, the user can more easily find the parking section where the vehicle is parked.

Here, while the smartphone 120 receives and displays information on a map of the parking lot from the server 130, the smartphone 120 displays a moving line from the user's current location to the location of the vehicle-parked section on the map of the parking lot using the location information transmitted from the second NFC tag 150 and the parking lot's feature information transmitted from the first NFC tag 110 so that the user can find the vehicle-parked section.

Further, when the parking lot is a ground parking lot in which the embedded GPS can be operated, the smartphone 120 may guide the user to find the vehicle-parked section through the augmented reality that displays a distance to be moved using, e.g., a number, and a direction using, e.g., an arrow mark, on the screen with the real world by operation of the camera, as well as the virtual reality that displays a distance to be moved using, e.g., a number, and a direction using, e.g., an arrow mark, on the virtual image transmitted from the server 130.

Further, when the parking lot is an underground parking lot in which the embedded GPS cannot be operated, the smartphone 120 may guide the user to find the vehicle-parked section through the virtual reality that displays a distance to be moved using, e.g., a number, and a direction using, e.g., an arrow mark, on the virtual image transmitted from the server 130.

Accordingly, the parking location checking system and the parking location checking method using the same according to an embodiment of the present invention can allow the user to more easily and quickly find the parking lot where the vehicle is parked so that the convenience of the parking lot user can be greatly increased.

Further, the parking location checking system and the parking location checking method using the same according to an embodiment of the present invention execute various information or advertisements to be exposed to the user when receiving and storing the location information of the parking lot in which the user's vehicle is parked from the first NFC tag 110, displaying the image of the user's vehicle-parked section, or displaying directions and distances from the current location to the location of the user's vehicle-parked section so that the user is guided to the vehicle parked-parking section.

Accordingly, when the user stores the location information on the vehicle-parked section in the smartphone 120 or receives the guidance of the location of the vehicle-parked section, advertisements are executed on the smartphone 120, and an additional profit using the advertisements can be created while using the parking location checking system.

Although described with reference to the preferred embodiments of the present invention, it should be understood by those of ordinary skill in the art that various modifications and changes in form and details may be made therein without departing from the spirit and scope of the present invention as set forth in the following claims.

What is claimed is:

1. A parking location checking system comprising:
a first near field communication (NFC) tag attached to at least one parking section of a parking lot and storing location information on the parking section and the parking lot's feature information on whether the parking lot where a user's vehicle is parked is a ground parking lot or an underground parking lot; and
a smartphone receiving the location information on the parking section where the user's vehicle is parked and the parking lot's feature information from the first NFC tag and storing the same when the smartphone is brought close or in contact to the first NFC tag attached to the parking section where the user's vehicle is parked after parking the vehicle on a desired parking section, so that when the user confirms the location where the vehicle is parked, the smartphone displays the location information on the parking section where the vehicle is parked, which is transmitted from the first NFC tag to be stored, so as to transmit such information to the user and executing an advertisement or information to be transferred to the user when the smartphone is brought close or in contact to the first NFC tag so as to receive and store the location information on the parking section where the user's vehicle is parked and the parking lot's feature information from the first NFC tag.

2. The parking location checking system of claim 1, further comprising a server transmitting an image of the parking section where the user's vehicle is parked to the smartphone when the user checks the location of the parking section where the user's vehicle is parked through the smartphone, so that the user checks the image of the parking section where the vehicle is parked, which is displayed through the smartphone.

3. The parking location checking system of claim 2, further comprising a camera taking an image of a parking section to which the first NFC tag is attached in real time and transmitting the image to the server when the user brings the smartphone close or in contact to the first NFC tag.

4. The parking location checking system of claim 2, wherein the server stores a pre-taken image of each parking section to which the first NFC tag is attached.

5. The parking location checking system of claim 1, wherein the smartphone executes the location information on the parking section where the user's vehicle is parked or the advertisement or the information to be transferred to the user when the smartphone displays the image of the parking section where the user's vehicle is parked.

6. The parking location checking system of claim 1, further comprising a second NFC tag attached to a structure or an entrance connected to the parking lot, transmitting user's current location information to the smartphone when the user brings the smartphone close or in contact to the second NFC tag so that by the smartphone, the user is guided to the parking section where the user's vehicle is parked, and storing parking lot's feature information on whether the parking section where the user's vehicle is parked is a ground parking lot or an underground parking lot.

7. The parking location checking system of claim 6, wherein the smartphone enables a moving line from the user's current location to the location of the parking section where the vehicle is parked to be displayed on a map of the parking lot received from the server using the user's current location information and the parking lot's feature information transmitted from the second NFC tag and the location information and the parking lot's feature information on the vehicle-parked section, transmitted from the first NFC tag.

8. The parking location checking system of claim 6, wherein the smartphone executes the advertisement or information to be transferred to the user when the smartphone is brought close or in contact to the second NFC tag so that the smartphone receives the user's current location information and parking lot's feature information from the second NFC tag.

9. The parking location checking system of claim 7, wherein while the smartphone operates a global positioning system (GPS) to display a direction and distance from the user's current location to the location of the parking section where the user's vehicle is parked, the smartphone displays a change of a remaining distance and direction of the user in real time to the location of the parking section where the user's vehicle is parked, so as to guide the user when the smartphone receives the parking lot's feature information from the second NFC tag and determines that the parking lot where the user's vehicle is parked is a ground parking lot.

10. The parking location checking system of claim 9, wherein the user is guided through augmented reality where while the smartphone displays the direction and distance from the user's current location to the location of the parking section on a screen with the real world displayed by the embedded camera operation, the smartphone displays the change of the remaining distance and direction of the user in real time to the location of the vehicle-parked section.

11. The parking location checking system of claim 9, wherein the user is guided through virtual reality where while the smartphone displays the direction and distance from the user's current location to the location of the parking section where the vehicle is parked on a virtual image of the parking lot displayed on the smartphone, transmitted from the server, the smartphone displays the change of the remaining distance and direction of the user in real time to the location of the parking section where the vehicle is parked.

12. The parking location checking system of claim 6, wherein the smartphone operates a geomagnetic sensor to display a direction and distance from the user's current location to the location of the parking section where the user's vehicle is parked, so as to guide the user when the smartphone receives the parking lot's feature information from the second NFC tag and determines that the parking lot where the user's vehicle is parked is an underground parking lot.

13. The parking location checking system of claim 12, wherein the user is guided through augmented reality where the smartphone displays the direction and distance from the user's current location to the location of the parking section where the vehicle is parked on a virtual image of the parking lot displayed the smartphone, transmitted from the server.

14. A parking location checking method, comprising the steps of:
transmitting and storing location information and parking lot's feature information on a parking section where a user's vehicle is parked from a first near field communication (NFC) tag to a smartphone by bringing or a smartphone close or in contact to the first NFC tag attached to the parking section after parking; and
displaying the location information on the parking section where the user's vehicle is parked by operating the smartphone,
wherein the smartphone executes an advertisement or information to be transferred to the user when the smartphone receives the location information and the parking lot's feature information on the parking section where the user's vehicle is parked from the first NFC tag.

15. The parking location checking method of claim 14, further comprising the step of transmitting an image of the parking section where the user's vehicle is parked from a server to the smartphone and storing the same, after the step of transmitting location information and parking lot's feature information on the user's vehicle-parked section and storing the same,
wherein when the image of the parking section where the user's vehicle is parked is transmitted and stored in the smartphone, the image of the parking section where the user's vehicle is parked is also displayed on the smartphone during a step of displaying the location information on the parking section where the user's vehicle is parked by operating the smartphone.

16. The parking location checking method of claim 15, wherein the step of transmitting the image of the parking section where the user's vehicle is parked from the server to the smartphone and storing the same comprises the steps of:
transmitting and storing a pre-taken image per parking section in the server;
transmitting the location information on the parking section where the vehicle is parked, which is stored in the smartphone to the server; and
receiving the image of the parking section from the server and storing the same on the smartphone, which is identical to the location information on the parking section where the vehicle is parked, stored in the smartphone.

17. The parking location checking method of claim 15, wherein the step of transmitting and storing an image of the parking section where the user's vehicle is parked from the server to the smartphone comprises the steps of:
taking an image of the user's vehicle-parked section in real time by operating a camera installed on a portion where the first NFC tag is positioned when the smartphone is brought close or in contact to the first NFC tag attached to the user's vehicle-parked section and transmitting the image to the server; and
receiving and storing the image of the parking section where the user's vehicle is parked from the server by the smartphone brought close or in contact to the first NFC tag.

18. The parking location checking method of claim 15, wherein the step of transmitting the image of the parking section where the user's vehicle is parked from the server to the smartphone and storing the same in the smartphone includes the smartphone's execution of the advertisement or information to be transferred to the user.

19. The parking location checking method of claim 15, wherein the step of displaying the location information on the user's vehicle-parked section by operating the smartphone includes the smartphone's execution of the advertisement or the information to be transferred to the user.

20. The parking location checking method of claim 14, further comprising the steps of transmitting the parking lot's feature information and user's current location information to the smartphone by bringing the smartphone close or in contact to a second NFC tag and guiding the user from the current location to the user's vehicle-parked location by the smartphone.

21. The parking location checking method of claim 20, wherein when the smartphone is brought close or in contact to the second NFC tag, the smartphone executes the advertisement or the information to be transferred to the user.

22. The parking location checking method of claim 20, wherein the step of guiding the user from the current location to the user's vehicle-parked location by the smartphone comprises the steps of:
receiving a map of the parking lot from a server by the smartphone and displaying the map; and
displaying a moving line from the user's current location to the parking section where the vehicle is parked using the user's current location information and the parking lot's feature information transmitted form the second NFC tag, and the location information on the parking section where the vehicle is parked and the parking lot's feature information transmitted form the first NFC tag.

23. The parking location checking method of claim 20, the step of guiding the user from the current location to the parking location where the user's vehicle is parked by the smartphone comprises the steps of:
determining whether the parking lot where the user's vehicle is parked is a ground parking lot or an underground parking lot by transmitting the parking lot's feature information from the second NFC tag to the smartphone; and
operating global positioning system (GPS) mounted in the smartphone when the smartphone determines that the parking lot is a ground parking lot or operating a geomagnetic sensor when the smartphone determines that the parking lot is an underground parking lot so that the smartphone displays a direction and distance from the user's current location to the location of the parking section where the user's vehicle is parked and guides the user.

24. The parking location checking method of claim 23, wherein the smartphone determines that the parking lot is a ground parking lot and operates the GPS, so that the user is guided through augmented reality where while the smartphone displays the direction and distance from the user's current location to the location of the parking section on a screen with the real world displayed by the smartphone's operation of the embedded camera, the smartphone displays a change of a remaining distance and direction of the user in real time to the location of the vehicle-parked section.

25. The parking location checking method of claim 23, wherein the smartphone determines that the parking lot is a ground parking lot and operates the GPS, so that the user is guided through virtual reality where while the smartphone displays the direction and distance from the user's current location to the location of the parking section where the vehicle is parked on a virtual image of the parking lot displayed on the smartphone, transmitted from the server, the smartphone displays a change of a remaining distance and direction of the user in real time to the location of the vehicle-parked section.

26. The parking location checking method of claim 23, wherein the smartphone determines that the parking lot is an underground parking lot and operates the geomagnetic sensor, so that the user is guided through virtual reality where the smartphone displays the direction and distance from the user's current location to the location of the parking section where the vehicle is parked on a virtual image of the parking lot displayed on the smartphone, transmitted from the server.
